(19) United States
(12) Patent Application Publication
(10) Pub. No.: US 2013/0262500 A1
(43) Pub. Date: Oct. 3, 2013

(54) METHODS AND SYSTEMS OF MONITORING NETWORK DEVICE PARAMETERS CHANGES

(71) Applicants: Iftah BRATSPIESS, Tel-Aviv (IL); Yossi Appelboum, Tel-Mond (IL); Bensi Ben-Atar, Nes Ziona (IL)

(72) Inventors: Iftah BRATSPIESS, Tel-Aviv (IL); Yossi Appelboum, Tel-Mond (IL); Bensi Ben-Atar, Nes Ziona (IL)

(73) Assignee: WebSilicon Network, Tel-Aviv (IL)

(21) Appl. No.: 13/432,107

(22) Filed: Mar. 28, 2012

(51) Int. Cl. G06F 17/30; G06F 15/16

(52) U.S. Cl. 707/769; 707/E17.014; 707/E17.032

(57) ABSTRACT

A network device that comprises a memory which stores a plurality monitored parameters divided to a plurality of clusters and a plurality of flags each associated with another of the plurality of clusters and an agent which monitors changes in the plurality monitored parameters and updates at least some of the plurality of flags accordingly. The agent receives at least one query from a monitoring entity during a polling cycle and uses the plurality of flags to identify which of the plurality of clusters includes a changed monitored parameter from the plurality monitored parameters.

### FIELD AND BACKGROUND OF THE INVENTION

The present invention, in some embodiments thereof, relates to network devices monitoring and, more particularly, but not exclusively, to methods and systems of monitoring changes of network device parameters.

Network devices in a network are monitored and administered using application layer protocols such as a Simple Network Management Protocol (SNMP). Usually a network monitoring station (NMS) gathers information about changes in the network devices. The information about the changes, such as configuration and behavioral changes in a network device, and response of network devices to a network change, constitute management information of the network devices. Software modules, such as SNMP agents running on the network devices, provide management information of the network devices to the NMS. According to conventional methods, the NMS may use asynchronous and synchronous monitoring mechanisms, to monitor the changes in the network devices. One such example of asynchronous monitoring is an SNMP-trap mechanism. In the SNMP-trap mechanism, the network device sends SNMP traps to the NMS if objects thereof are changed. However, it is possible that in some cases, the SNMP traps are not received by the NMS. As a result, the SNMP-trap mechanism is not completely reliable. In another conventional method, the NMS may use SNMP polling as a synchronous monitoring mechanism for monitoring changes. In SNMP polling, the NMS periodically polls the network devices for changes. The periodic polling results in detecting changes in the network devices that have occurred between two subsequent time periods. SNMP polling is more reliable in comparison to asynchronous mechanisms. Moreover, SNMP polling does not require highly-available NMS.

### SUMMARY OF THE INVENTION

According to some embodiments of the present invention, there is provided a network device. The network device comprises a memory which stores a plurality monitored parameters divided to a plurality of clusters and a plurality of flags each associated with another of the plurality of clusters and an agent which monitors changes in the plurality monitored parameters and updates at least some of the plurality of flags accordingly. The agent receives at least one query from a monitoring entity during a polling cycle and uses the plurality of flags to identify which of the plurality of clusters includes a changed monitored parameter from the plurality monitored parameters.

Optionally, each of the plurality of flags is a time tag, the agent updates a time indicative of the occurrence of the changes in respective flags of the at least some flags.

Optionally, the agent responds to the query with a subgroup of the plurality monitored parameters which is selected from the identified cluster.

Optionally, the network device further comprises a mapping dataset which maps the plurality of flags, the agent uses the mapping dataset to identify which of the plurality of clusters includes the changed monitored parameter.

Optionally, the memory stores a plurality of sub flags each associated with another of a plurality of sub clusters of one of the plurality of clusters, the agent updates the plurality of sub flags according to respective the monitored changes and identify which of respective the plurality of sub clusters includes the changed monitored parameter.

More optionally, the agent responds to the query with a subgroup of the plurality monitored parameters, the subgroup is contained in the identified sub cluster.

Optionally, the plurality monitored parameters comprises a plurality of monitored vector parameters each having a plurality of elements and divided to a plurality of element groups, at least some of the plurality of flags being a associated with the plurality of element groups and with the plurality of monitored vector parameters, the agent monitors the changes in the plurality of elements and updates the at least some flags accordingly.

According to some embodiments of the present invention, there is provided a system having a plurality of network devices each defined as the network device defined above and a monitoring entity which transmits the at least one query to the plurality of network devices via a computer network.

Optionally, the monitoring entity generates and transmits the at least one query to each one of the plurality of network devices according to a polling rate adapted to a respective estimated variability rate of respective the plurality of clusters.

According to some embodiments of the present invention, there is provided a method of discovering monitored parameters data of a network device. The method comprises receiving from a monitoring entity a query for changes occurred in a plurality of monitored parameters divided to a plurality of clusters, matching a plurality of flags each associated with another of the plurality of clusters with a previous version of the plurality of flags to identify at least one which of the plurality of clusters includes at least one changed member, and responding to the query with at least one response comprising the at least one changed member.

Optionally, the method further comprises monitoring the changes and updating the plurality of flags according to the monitoring.

Optionally, the plurality of flags and the previous version of the plurality of flags are recorded during different polling cycles.

According to some embodiments of the present invention, there is provided a network device that comprises a memory which stores a plurality monitored vector parameters each having a plurality of elements and divided to a plurality of element groups, the memory stores a plurality of flags each associated with another of the plurality of monitored vector parameters and the plurality of flags and an agent which monitors changes in the plurality of elements and updates at least some of the plurality of flags accordingly, the agent receives at least one query from a monitoring entity during a polling cycle and uses the plurality of flags to identify which of the plurality of element groups includes a changed element from the plurality of elements.

Optionally, the agent respond to the at least one query with a plurality of responses each comprises another member of the identified element group.

According to some embodiments of the present invention, there is provided a method of generating a mapping dataset of monitored parameters of a network device. The method comprises providing a plurality of monitored parameters of a network device, dividing the plurality of monitored parameters among a plurality of groups, each according to an estimated variability rate, associating each one of the plurality of groups with a flag, associating each of a plurality of sub groups of each of the plurality of groups with a sub flag, creating a mapping dataset which maps each the flag and each the sub flag, and outputting the mapping dataset.

Optionally, the mapping dataset comprises a plurality of pointers to each the flag and to each the sub flag.

According to some embodiments of the present invention, there is provided a method of polling a network device. The method comprises acquiring a plurality of variability rate values from a network device each the variability rate value is associated with another of a plurality of clusters of a plurality of monitored parameters, assigning a plurality of polling rates each adapted for monitoring another of the plurality of clusters, and sending a plurality of polling queries to the network device during a plurality of polling cycles. The plurality of polling queries are send to poll changes to monitored parameters of each the cluster according to a respective polling rate of the plurality of polling rates which is assigned thereto.

Optionally, the method further comprises receiving a plurality of responses to the plurality of queries; wherein the acquiring, the assigning, the sending, and the receiving are performed during each of a plurality of polling cycles.

Optionally, the receiving comprises identifying all changes to the plurality of monitored parameters since a previous polling cycle of the plurality of polling cycles.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system having a monitoring entity 101 that monitors changes in a plurality of network devices, according to some embodiments of the present invention;

FIG. 2 is a flowchart of a method of mapping a plurality of monitored parameters of a network device, according to some embodiments of the present invention; and

FIG. 3 is a flowchart of a schematic polling cycle wherein an exemplary network device having the above flags, is polled by the monitoring device, according to some embodiments of the present invention.

### DESCRIPTION OF EMBODIMENTS OF THE INVENTION

The present invention, in some embodiments thereof, relates to network devices monitoring and, more particularly, but not exclusively, to methods and systems of monitoring changes of network device parameters.

According to some embodiments of the present invention, there are provided methods of using agents and an agent, such as a simple network management protocol (SNMP) agent, that detects, optionally continuously or sequentially, change(s) in a plurality of monitored parameters (or elements of the parameters) of a hosting network device and manages a mapping dataset, such as a dataset of flags, for example time tags, which is indicative in which of a plurality of groups of the monitored parameters and/or of elements of a certain monitored parameter the change(s) occurred. In use, the dataset is used for reducing the bandwidth and/or optionally computational complexity that a monitoring entity, such as a network monitoring system (NMS), consumes while polling the network device for changes. According to some embodiments of the present invention, the groups include a number of monitored parameters or a number of elements of a monitored parameter with a common estimated variability rate. In such embodiments, different groups, also referred to as clusters (may be referred to interchangeably), may be polled in different rates. Groups may be sub clusters of a cluster of monitored parameters having a common estimated variability rate and/or groups of elements, such as rows, of a monitored vector parameter, such as a table having a known estimated variability rate.

According to some embodiments of the present invention, there are provided methods and systems of generating a mapping dataset of monitored parameters of a network device. The method is based on a plurality of monitored parameters (scalar or vector) of a network device which are divided among a plurality of clusters, each according to an estimated variability rate. Each one of the plurality of clusters is associated with a flag and each one of a plurality of sub clusters of each of the clusters is associated with a sub flag. This allows creating a mapping dataset which either comprises a plurality of pointers to each flag and sub flag or the flags and sub flags themselves. The mapping dataset may be outputted, for example installed in the network device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

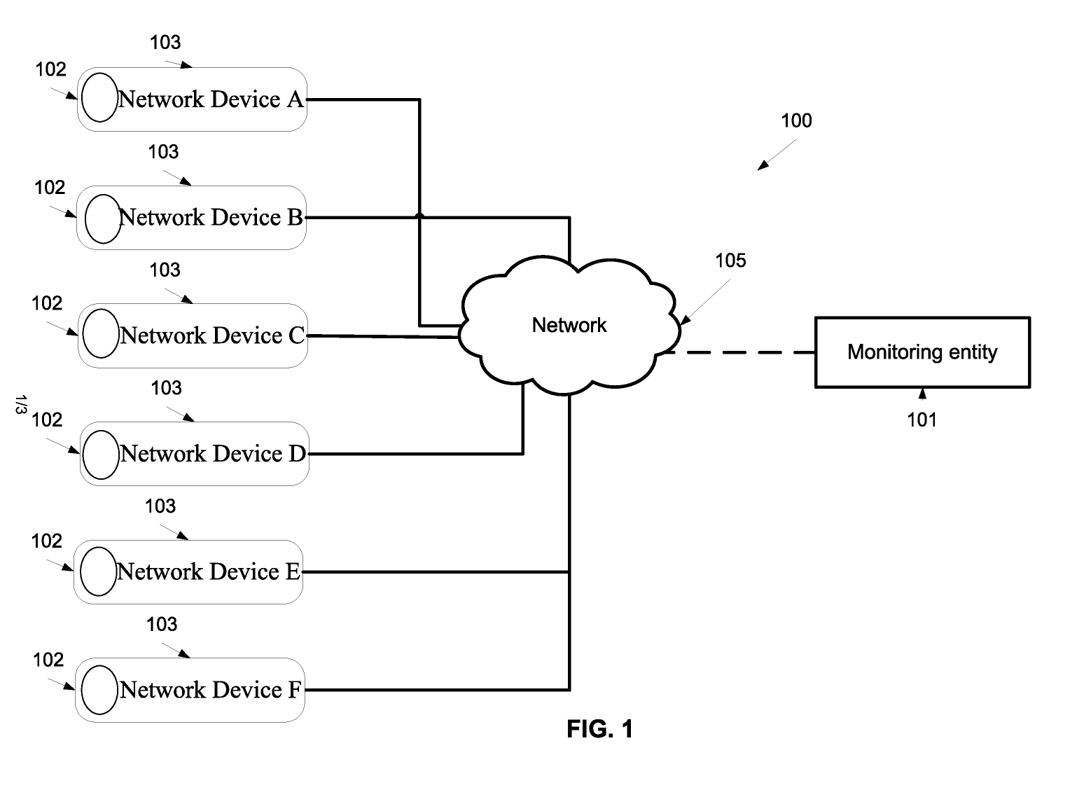

Reference is now made to FIG. 1, which is a schematic illustration of a system 100 having a monitoring entity 101, such as an NMS 101, that monitors changes in a plurality of network devices 103 which are connected to a common network 105, such as an Ethernet or the Internet and a plurality of agents 102, such as SNMP agents, installed in the plurality of network devices 103 and communicate with the monitoring entity 101, according to some embodiments of the present invention. The number of network devices 103 may vary from less than a hundred to more than 100,000, for example 50,000, 150,000, and 500,000 or even more. Examples of network devices 103 include, but are not limited to, gateways, routers, firewalls, repeaters, bridges, and switches. Network devices 103 are optionally connected in any network topology, for example a ring, a tree, a star, a bus, a mesh, and/or the like. The system 100 allows managing large scale networks of about 100,000 or even more network devices with limited bandwidth consumption. Moreover, the system 100 allows managing high complexity devices with numerous monitored parameters with polling cycles which are based on a limited number of messages.

The monitoring entity 101 continuously monitors changes taking place in network devices 103 during a plurality of monitoring polling cycles. Optionally, the monitoring entity 101 monitors scalar and/or vector parameters of the network devices 103 by a periodic polling mechanism. The monitored parameters include information related to changes in network devices 103. The information may include parameter changes, such as configuration and/or behavioral changes and/or an outcome of these changes in network devices 103. Optionally, during a polling cycle, the monitoring entity 101 sends requests to the agents 102 for detecting changes. The agents 102, which are optionally SNMP agents, receive the requests, process the requests, and send responses to the monitoring entity 101, for example as SNMP packets.

According to some embodiments of the present invention, in use, each agent 102 updates a dataset of flags according to changes to the monitored parameters so that the dataset of flags is indicative of which cluster of scalar parameters and/or group of elements of a vector parameter, for example rows of a table, include a changed parameter or element. During polling cycles, the updated dataset of flags is used to identify changed parameters or a portion thereof with low computational complexity and transmitting the changed parameters or portion thereof to the monitoring entity 101 with limited bandwidth. Optionally, for example as further described below, parameters may be assigned to groups according to their estimated variability rate. As used herein, an estimated variability rate is the estimated rate at which changes occur to a monitored scalar parameter.

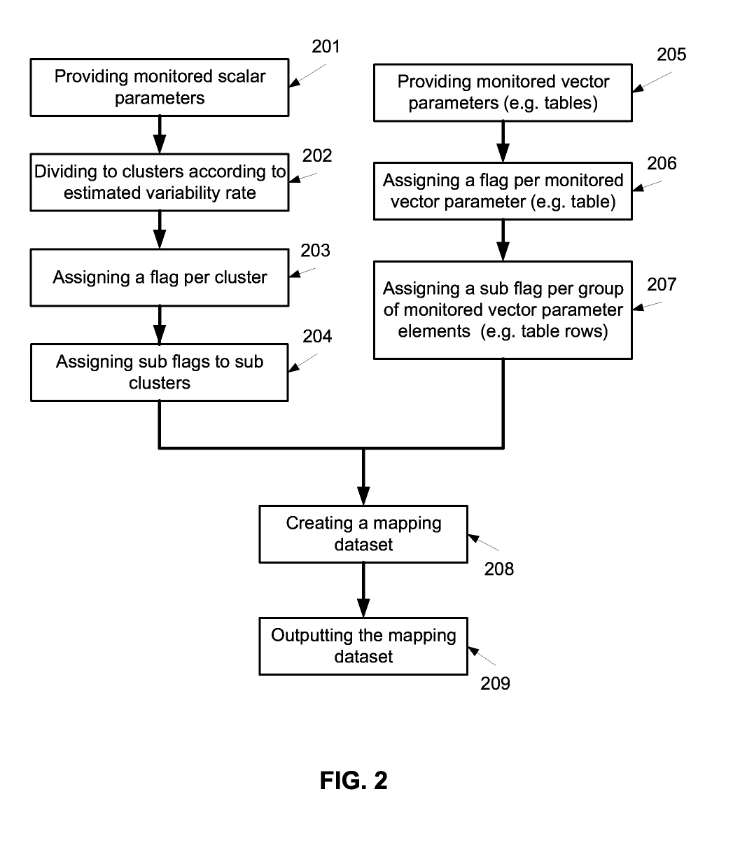

Reference is also made to FIG. 2, which is a flowchart 200 of a method of mapping a plurality of monitored parameters of a network device 103, for example for usage of a respective agent 102, according to some embodiments of the present invention. The mapping allows generating a dataset of flags, as described above. Optionally, the mapping creates a mapping dataset that facilitates monitoring changes of monitored parameters at the network device 103 using a limited number of messages in the communication between the monitoring entity 101 and the network device 103 (e.g. requests and responses). The mapping dataset optionally includes pointers to flags, such as time tags, which are indicative of changes to groups of parameters which are optionally categorized according to estimated variability rates.

As shown at 201, monitored scalar parameters of the network device 101 are provided. Then, as shown at 202, the plurality of monitored scalar parameters are divided among a plurality of clusters according to an estimated variability rate. Optionally, each one of the plurality of clusters is tagged with variability rate label indicative of the estimated variability rate of the monitored scalar parameters it contains.

The estimated variability rate may be manually defined by an operator and/or automatically set by a module, for example according to a statistical historical analysis and/or expert opinion. For example, monitored scalar parameters may be divided into static and dynamic clusters where static parameters are randomly changed at very low rate (if any) and dynamic parameters are changed at a higher rate, optionally as an outcome of cyclic, repetitive and/or expected events. Optionally, the monitored scalar parameters may be divided among a number of clusters representing sub categories, for example a low variability rate category, a high variability rate category and a continuous variability category. Optionally, different clusters are set to be monitored in different rates, for example according to their estimated variability rate. In such embodiments, clusters with static parameters are polled at lower rates than dynamic parameters. Different dynamic parameters may be polled at different rates according to respective estimated variability rates.

Now, as shown at 203, a flag, for example a time tag, is associated with each cluster to indicate a change to one or more of the monitored scalar parameters of the cluster. For example, the flag is a time tag indicating the time in millisecond (mSec) the last change occurred to a cluster member, for example according to a real time clock (RTC) module. Optionally, the current uptime value of the respective network device 103 at the time the change occurs is set as the time tag.

In such an embodiment, an array that includes the above flags may indicate which of the clusters include monitored scalar parameters which have changed since the last polling cycle.

Optionally, as shown at 204, a sub flag, for example a time tag, is associated with each sub cluster of each cluster to indicate a change to one or more of the monitored scalar parameters of the sub cluster. For example a sub cluster may include about 10 monitored scalar parameters. In such an embodiment, an array that includes the above sub flags may indicate which of the sub clusters includes one or more monitored scalar parameters which have been changed since the last polling cycle. For example, when sub clusters are of size of 10 monitored scalar parameters, a cluster, such as a high variability rate cluster, which includes 60 monitored scalar parameters, is divided to 6 sub clusters each associated with a different sub flags. In such am embodiment, the 10 monitored scalar parameters may be forwarded in a single response message.

Additionally or alternately, as shown at 205, a plurality of monitored vector parameters is provided. Each monitored vector parameter includes a plurality of elements. For example, a monitored vector parameter is a table which includes a plurality of rows. The monitored vector parameter is optionally divided to groups of elements, for example, groups of rows of a table. Optionally, different monitored vector parameters, for example tables, are associated with different estimated variability rates. Optionally, each one of the plurality of monitored vector parameters is tagged with variability rate label indicative of the estimated variability rate of the elements it contains. Now, as shown at 206, a vector flag, for example a time tag, is associated with each monitored vector parameter to indicate that a change occurred to an element in a certain element group. For example, the flag is a time tag which indicates the time in mSec the last change to an element in any of the element groups occurred. Optionally, the current uptime value of the respective network device 103 at the time the change occurs is set as the time tag. Optionally, as shown at 207, a sub flag, for example a similar time tag, is associated with each element group to indicate a change to one or more of its elements. For example, an element group may include about 5 rows of data in a table. In such an embodiment, an array that includes the above sub flags may indicate which of the element groups includes one or more rows which have been changed since the last polling cycle. In such embodiments, each table is associated with a flag added to a flag array and for a certain amount of table rows, for example 5, a sub flag is assigned. For example, a table with 100 rows is associated with 20 sub flags.

Now, as shown at 208, a mapping dataset that maps the flags, sub flags, and optionally the relation therebetween is created and stored at the network device 103. The mapping dataset optionally stores pointers to each one of the flags and the sub flags.

Optionally, as shown at 209, the mapping dataset is now outputted, for example to be used for a polling communication protocol wherein the monitoring device 101 queries the network devices 103 for changes to monitored parameters.

During the operation of the network device 103, a respective agent 102 updates a sub flag with a current time value when one or more of its monitored scalar parameters and/or elements of monitored vector parameters are changed. In such a manner, sub flag includes a value indicative of the timing of the last change to one of its monitored scalar and/or vector parameters. In addition, the agent 102 updates a flag with a current time value when one or more of its sub flags are updated. In such a manner, the flag includes a value indicative of the timing of the last change to one of its sub flags, namely a value indicative of the timing of the last change to one of the monitored scalar parameters and/or elements of the monitored vector parameters.

During each polling cycle, the mapping dataset is used for detecting and polling changed monitored scalar parameters and/or elements of monitored vector parameters. First, flags are checked to identify a time value change in relation to a previous polling cycle. If a time value change is detected, then sub flags of the respective flags are checked to identify a time value change in relation to a previous polling cycle. If a time value change is detected, then a group of monitored scalar parameters or a group of elements of monitored vector parameter, which is associated with the sub flag, is forwarded as a response to the querying monitoring entity 101. In such embodiments, only a limited group of monitored parameters is forwarded to the querying monitoring entity 101. This reduces the bandwidth required for the polling process and the number of messages which are sent for polling changed monitored scalar and/or vector parameters.

For example, the network device 101 is a simple device with about 50 monitored scalar parameters. The monitored scalar parameters are clustered according to an estimated variability rate, for example 20 monitored scalar parameters are identified as substantially static, 10 monitored scalar parameters are identified as changing relatively slowly every 30 minutes, 10 monitored scalar parameters are identified as changing relatively fast, every 2 minutes, and 10 monitored scalar parameters are identified as changing continuously. The exemplary simple device includes 3 monitored vector parameters, tables having 20 rows each, one table never changes, one table includes 25% of the rows which change every 10 minutes and another table includes 25% of the rows which change continuously. During a polling cycle, one query message is sent from the monitoring entity for identifying a change in the flags of the monitored scalar parameters (3 flags), and three query messages are sent to identify a change each in the tables, each query for another table, so that a total of 8 messages is required (4 queries and 4 responses) to find changed monitored scalar and/or vector parameters during a polling cycle. When a change is discovered in a monitored scalar parameter, for example when the flag and sub flag time value are different from the recorded flags in a previous polling cycle, the monitored scalar parameters in the sub-cluster that is pointed by the changed sub flag is polled by 1 additional query.

When a change is discovered in an element of a monitored vector parameter, for example when the time value of a flag and a sub flag are different from the recorded flags in a previous polling cycle, the elements of the monitored vector parameter are polled by a number of queries, each for another element, for example 5 additional queries in the above case of a table.

According to some embodiments of the present invention, the monitoring entity 101 updates the rate at which the network device and/or certain clusters of monitored scalar parameters and/or monitored vector parameters are polled according to an actual rate of changes.

For example, the monitoring entity 101 gathers variability rate labels indicative of the estimated variability rates pertaining to the sub clusters and/or monitored vector parameters, such as tables, of each network device during a device discovery process (e.g. static, slow change, fast change, continuous change and/or the like). Then, the monitoring entity 101 sets, optionally automatically, an adapted polling rate for each one of the sub clusters and/or monitored vector parameters according to the respective estimated variability rates.

Optionally, a current discovery process which includes the following phases: device existence check (phase I), device type check (phase II) and device deep discovery (phase III) is adapted for generating an adapted polling rate per sub clusters and/or monitored vector parameter by adding a variability rate discovery phase between phase II and phase III. During the variability rate discovery phase, the monitoring entity 101 reads the variability rate labels. Optionally, the variability rate labels are attached to respective pointers to flags at the above mentioned mapping dataset.

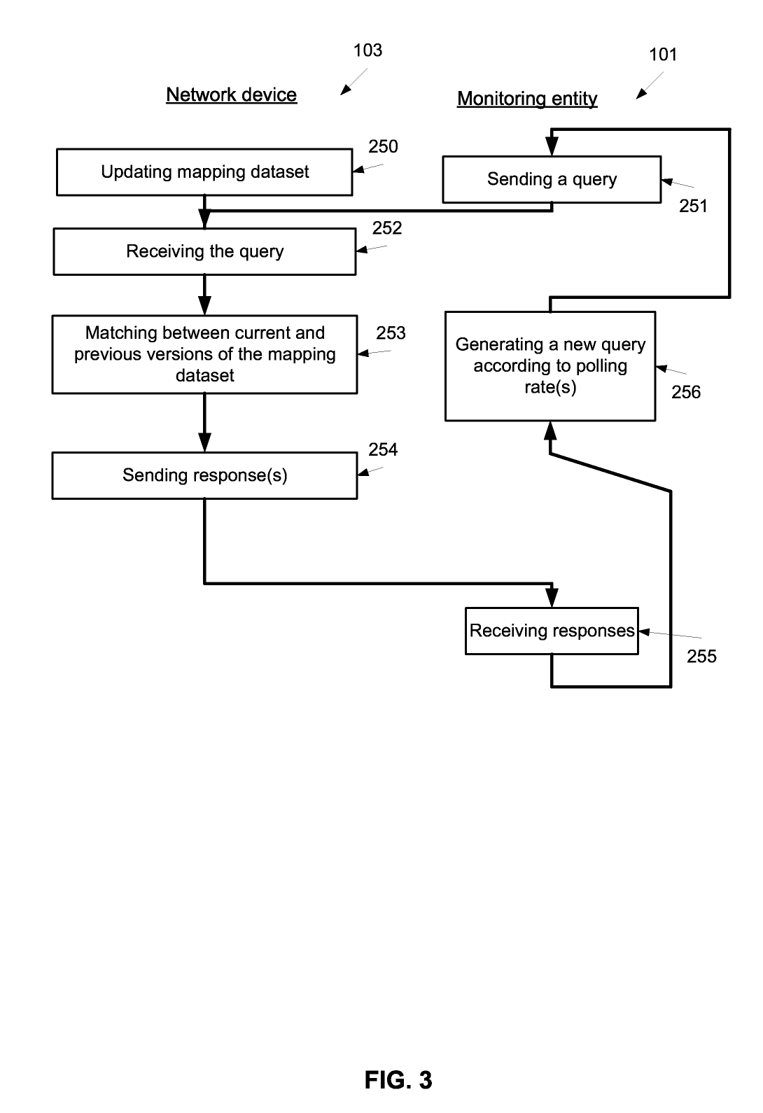

Reference is now also made to FIG. 3, which is a flowchart of a schematic polling cycle 249 wherein an exemplary network device 103 having the above flags, is polled by the monitoring device 101, according to some embodiments of the present invention. Optionally, the queries generated by the monitoring device 101 are sent according to adapted polling rates which are calculated as described above. As shown at 250 and described above, a mapping dataset, for example a set of flags (including sub flags), is updated according to the changes to the respective monitored parameters, for example monitored scalar parameters and elements of monitored vector parameters. As shown at 251, during a polling cycle, the monitoring entity 101 sends a query. The network device 103 then receives the query 252 and matches current version of a mapping dataset with a previous version thereof, for example the flags with a previous version thereof 253, for example as described above. Now, based on the match, one or more sub clusters of scalar parameters and/or elements of the vector parameters, for example rows of tables are sent in response to the query in one or more response message(s), as shown at 254. The monitoring entity 101 receives the response message(s) and record and/or otherwise process the detected changes, for example according to any SNMP process, as shown at 255. As shown at 256, a new query for the following polling cycle is generated, optionally based on adapted polling rates. The polling cycle is optionally performed between the monitoring entity 101 and a plurality of separate network devices 103.

By using the above polling method, the number of messages, which are required for polling changed monitored parameters from a device network, is smaller than the number of messages which are required for polling changed monitored parameters using known polling methods wherein all the monitored parameters are directly polled and/or checked by the monitoring entity 101.

For example, when a known polling method is used for polling the above simple device, each polling cycle requires 5 requests for retrieving a monitored scalar parameter (on each request 10 monitored scalar parameters are polled) and 60 requests for retrieving a monitored vector parameters, such as tables data where on each request one table row is polled. Total polling cycle is 65 requests and 65 responses, a total of 130 messages. On the other hand, if the above polling method is used with the same polling cycle rate, changes from all monitored scalar parameters may be acquired using 1.50333 queries and 1.50333 responses per each polling cycle on average. For the tables, the first table requires no queries (never changed), the second table requires 5 queries every tenth polling cycle and third table that requires 5 queries every polling cycle. To summarize, a total of 1.5 queries per cycle and same number of responses per cycle is required. The total messages per polling cycle for such a network device is 14.0666 messages in relation to 130 messages which are required using a common protocol, namely about almost 90% reduction.

In another example, a complex device with about 150 monitored scalar parameters is monitored where 75 are static, 25 are change slowly (i.e. every 30 minutes), 25 are fast changed (i.e. every 2 minutes) and 25 are changed continuously, 10 tables (5 static that never changes, 3 that 25% of them changes every 10 minutes and another 2 that 25% of them changes all the time) and 10 tables, each with about 50 rows. A polling cycle for such a device according to the known methods requires 1030 messages (15 requests for monitored scalar parameters, 500 for the monitored tables and same numbers for responses). On the other hand, if the above polling method is used with the same polling cycle rate, only about 60 messages (queries and responses) are needed on average to monitor changes in the above complex device. In particular, changes from all monitored parameters may be detected by 22 messages, 11 queries and 11 responses, where one query message is used for the scalar flags and one query per each one of the tables. When a change is discovered, for example when the time value of one sub flag is different from the same flag in a previous polling cycle, the sub-cluster and/or group of elements that is pointed by that sub flag is polled by one query in case of monitored scalar parameter and 5 queries for 5 rows in case of a table. Similarly to the described above, the cluster of static monitored scalar parameters does not updated, the slow changed monitored scalar parameters are updated once every 30 polling cycles, the fast changed monitored scalar parameters are updated once every 2 cycles and the continuously changed monitored scalar parameters are continuously updated. Therefore, all monitored scalar parameters may be monitored by 4.6 queries and 4.6 responses on each polling cycle. For the tables, 5 tables do not require queries, 3 tables require 12.5 queries every tenth polling cycle, and 2 tables require 12.5 queries every polling cycle, a total of 28.75 queries and 28.75 responses. The total messages per polling cycle for the network device is 88.7 messages comparing to 1030 messages before, namely about 92% reduction.

In another example, a high complexity device with about 500 monitored scalar parameters is monitored where 250 are static, 100 are change slowly (i.e. every 30 minutes), 75 are changed (i.e. every 2 minutes) and 75 are changed continuously, 30 tables (15 static that never changes, 10 that 25% of them changes every 10 minutes and another 5 that 25% of them changes all the time) and 10 tables, each with about 250 rows. A polling cycle for such a device according to the known methods requires 15,100 messages (50 requests for monitored scalar parameters, 7500 for the monitored tables and same numbers for responses). On the other hand, if the above polling method is used with the same polling cycle rate, only about 930 messages (queries and responses) are needed on average to monitor changes in the above high complexity device. In particular, changes from all monitored parameters may be detected by 62 messages, 31 queries and 31 responses, where one query message is used for the scalar flags and one query per each one of the tables. When a change is discovered, for example when the time value of one sub flag is different from the same flag in a previous polling cycle, the sub-cluster and/or group of elements that is pointed by that sub flag is polled by one query in case of monitored scalar parameter and 5 queries for 5 rows in case of a table. Similarly to the described above, the cluster of static monitored scalar parameters does not updated, the slow changed monitored scalar parameters are updated once every 30 polling cycles, the fast changed monitored scalar parameters are updated once every 2 cycles and the continuously changed monitored scalar parameters are continuously updated. Therefore, all monitored scalar parameters may be monitored by 12.3333 queries and 12.3333 responses on each polling cycle. For the tables, 15 tables do not require queries, 10 tables require 75 queries every tenth polling cycle, and 5 tables require 75 queries every polling cycle, a total of 462.333 queries and 462.333 responses. The total number of messages per polling cycle for the network device is 924.666 messages comparing to 15,100 messages before, namely about 94% reduction.

It is expected that during the life of a patent maturing from this application many relevant methods and systems will be developed and the scope of the term an agent, a network device and a monitoring entity is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A network device, comprising:
a memory which stores a plurality monitored parameters divided to a plurality of clusters and a plurality of flags each associated with another of said plurality of clusters; and
an agent which monitors changes in said plurality monitored parameters and updates at least some of said plurality of flags accordingly;
wherein said agent receives at least one query from a monitoring entity during a polling cycle and uses said plurality of flags to identify which of said plurality of clusters includes a changed monitored parameter from said plurality monitored parameters.

2. The network device of claim 1, wherein each of said plurality of flags is a time tag, said agent updates a time indicative of the occurrence of said changes in respective flags of said at least some flags.

3. The network device of claim 1, wherein said agent responds to said query with a subgroup of said plurality monitored parameters which is selected from said identified cluster.

4. The network device of claim 1, further comprising a mapping dataset which maps said plurality of flags, said agent uses said mapping dataset to identify which of said plurality of clusters includes said changed monitored parameter.

5. The network device of claim 1, wherein said memory stores a plurality of sub flags each associated with another of a plurality of sub clusters of one of said plurality of clusters, said agent updates said plurality of sub flags according to respective said monitored changes and identify which of respective said plurality of sub clusters includes said changed monitored parameter.

6. The network device of claim 5, wherein said agent responds to said query with a subgroup of said plurality monitored parameters, said subgroup is contained in said identified sub cluster.

7. The network device of claim 1, wherein said plurality monitored parameters comprises a plurality of monitored vector parameters each having a plurality of elements and divided to a plurality of element groups, at least some of said plurality of flags being a associated with said plurality of element groups and with said plurality of monitored vector parameters, said agent monitors said changes in said plurality of elements and updates said at least some flags accordingly.

8. A system having a plurality of network devices each defined as the network device defined in claim 1 and a monitoring entity which transmits said at least one query to said plurality of network devices via a computer network.

9. The system of claim 8, wherein said monitoring entity generates and transmits said at least one query to each one of said plurality of network devices according to a polling rate adapted to a respective estimated variability rate of respective said plurality of clusters.

10. A method of discovering monitored parameters data of a network device, comprising:
receiving from a monitoring entity a query for changes occurred in a plurality of monitored parameters divided to a plurality of clusters;
matching a plurality of flags each associated with another of said plurality of clusters with a previous version of said plurality of flags to identify at least one which of said plurality of clusters includes at least one changed member; and
responding to said query with at least one response comprising said at least one changed member.

11. The method of claim 10, further comprising monitoring said changes and updating said plurality of flags according to said monitoring.

12. The method of claim 10, wherein said plurality of flags and said previous version of said plurality of flags are recorded during different polling cycles.

13. A network device, comprising:
a memory which stores a plurality monitored vector parameters each having a plurality of elements and divided to a plurality of element groups, said memory stores a plurality of flags each associated with another of said plurality of monitored vector parameters and said plurality of flags; and
an agent which monitors changes in said plurality of elements and updates at least some of said plurality of flags accordingly, said agent receives at least one query from a monitoring entity during a polling cycle and uses said plurality of flags to identify which of said plurality of element groups includes a changed element from said plurality of elements.

14. The network device of claim 13, wherein said agent respond to said at least one query with a plurality of responses each comprises another member of said identified element group.

15. A method of generating a mapping dataset of monitored parameters of a network device, comprising:
providing a plurality of monitored parameters of a network device;
dividing said plurality of monitored parameters among a plurality of groups, each according to an estimated variability rate;
associating each one of said plurality of groups with a flag;
associating each of a plurality of sub groups of each of said plurality of groups with a sub flag;
creating a mapping dataset which maps each said flag and each said sub flag; and
outputting said mapping dataset.

16. The method of claim 15, wherein said outputting is performed for installment in said network device.

17. The method of claim 15, wherein said mapping dataset comprises a plurality of pointers to each said flag and to each said sub flag.

18. A computer readable medium comprising computer executable instructions adapted to perform the method of claim 15.

19. A method of polling a network device, comprising:
acquiring a plurality of variability rate values from a network device each said variability rate value is associated with another of a plurality of clusters of a plurality of monitored parameters;
assigning a plurality of polling rates each adapted for monitoring another of said plurality of clusters; and
sending a plurality of polling queries to said network device during a plurality of polling cycles;
wherein said plurality of polling queries are send to poll changes to monitored parameters of each said cluster according to a respective polling rate of said plurality of polling rates which is assigned thereto.

20. The method of claim 19, further comprising receiving a plurality of responses to said plurality of queries; wherein said acquiring, said assigning, said sending, and said receiving are performed during each of a plurality of polling cycles.

21. The method of claim 20, wherein said receiving comprises identifying all changes to said plurality of monitored parameters since a previous polling cycle of said plurality of polling cycles.
